(19) United States
(12) Patent Application Publication
(10) Pub. No.: US 2026/0272205 A1
(43) Pub. Date: Sep. 17, 2026

(54) PRESSURE VALVE FOR COOKING APPARATUS

(71) Applicant: Raja Singh Tuli, Montreal (CA)

(72) Inventor: Raja Singh Tuli, Montreal (CA)

(21) Appl. No.: 19/559,854

(22) Filed: Mar. 6, 2026

Related U.S. Application Data
(60) Provisional application No. 63/769,843, filed on Mar. 11, 2025.

(51) Int. Cl. A47J 27/09

(52) U.S. Cl. CPC A47J 27/09

(57) ABSTRACT

The present invention introduces an apparatus and method for cooking the foodstuff in a pressurized steam oven with the foodstuff being steam cooked in the first stage and seared in the next stage. Various pressure cooking valve configurations are presented to enhance safety and cooking efficiency. In one configuration, a valve on the cooking apparatus lid is designed to protect the seal from extreme searing temperatures. Another configuration involves positioning the valve slightly apart from the cooking apparatus using an elongated metal pipe. This pipe, equipped with evenly distributed fins, enables swift cooling of hot steam, ensuring the safety of the valve and the steam or air pumps responsible for managing airflow situated behind it.

### CROSS-REFERENCE TO RELATED APPLICATIONS

This application claims priority to U.S. provisional patent application No. 63/769,843, entitled “PRESSURE VALVE FOR COOKING APPARATUS,” filed on Mar. 11, 2025. The content of this U.S. provisional patent application is hereby incorporated by reference in its entirety for all purposes.

### BACKGROUND OF THE INVENTION

### Field of the Invention

The present disclosure generally relates to the field of steam ovens for cooking foodstuffs such as meats and vegetables, in a faster, more efficient manner. More particularly, the invention relates to steam discharge valves of pressure cookers used for cooking the foodstuff in a pressurized steam oven with the foodstuff being steam cooked in a first stage and seared in a second stage. The invention also relates to the technical field of cooking appliances, in particular to a steam oven control method and device, cooking equipment, steam cooking, and searing all-in-one machine.

### Description of Related Art

The emergence of intelligent household appliances, including steaming and baking ovens, has significantly enhanced our daily lives by offering a wide range of conveniences. Notably, recent advancements in electric pressure cooker technology have revolutionized cooking by efficiently converting electrical energy into heat energy, allowing for the convenient preparation of delicious meals. Electric pressure cookers operate on the principle of elevating the boiling point, thereby achieving high-quality cooking results at increased pressure levels. These pressure cookers are equipped with a lid featuring a pressure relief valve, which regulates the desired working pressure within the pot.

However, due to the consistently high temperature and pressure maintained inside electric pressure cookers, there is a risk of explosion accidents if internal steam pressure rises abnormally during the cooking process. This danger persists even when transitioning from cooking to warming settings. Pressure cooking pots are designed as pressure vessels and must adhere to stringent safety standards. To mitigate potential hazards, a steam discharge valve is incorporated to expel excess steam safely.

Conventional pressure cookers typically consist of a pot with peripheral grooves or similar features to secure a compatible lid. Unfortunately, these pressure cookers are generally unsuitable for conventional cooking purposes due to the specialized locking mechanisms on the pot.

A critical component of these pressure cookers is the gasket, which ensures a hermetic seal against the lid. Under the influence of a spring, the gasket tightly encircles an orifice, working in conjunction with the head to create a sealed chamber that prevents steam leakage. When the internal pressure exceeds a predetermined threshold, the spring-compressed head and gasket release the orifice, thereby automatically regulating the internal pressure.

In scenarios such as reverse searing in a steam oven, food is subjected to a two-stage process, involving pressure cooking followed by steam release and searing, all within the same oven. This necessitates temperature fluctuations between the stages. Typically, sealing gaskets made from materials like silicon or rubber cannot withstand temperatures as high as 350° F.

Hence, there is a pressing need for an enhanced cooking apparatus and pressure valves specifically designed for steam cooking equipment to extend the safety valve's operational lifespan. Consequently, the present invention aims to provide a cooking apparatus for efficiently cooking food items, such as meats and vegetables, in a faster and more effective manner, while also addressing various valve designs to enhance the durability of silicon or rubber sealing components.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to cooking foodstuffs such as meats and vegetables, in a faster, more efficient manner. More particularly, the invention relates to steam release valves of a pressure cooker used for cooking the foodstuff in a pressurized steam environment with the foodstuff being steam cooked in a first stage and seared in a second stage. The purpose of the present invention is to provide a faster and more efficient method of cooking food items while maintaining high product yield. Additionally, the invention can help in cooking and browning food items evenly in a single cycle.

In a preferred embodiment of the present invention, the cooking apparatus is designed to improve pressure regulation during cooking. The apparatus includes a vessel for food placement and a precisely fitting lid that, when combined with a gasket, forms a sealed cooking chamber, allowing for effective pressure control. In one embodiment, both the vessel and the lid have a double-walled structure with insulation in between. The lid comprises a valve. The valve is strategically positioned away from the lid, allowing it to cool to a temperature below the searing temperature. Inside the valve, a seal ensures a tight closure. Additionally, fins on the valve may provide rapid cooling. The disclosed arrangement ensures that the seal remains safe even at high internal temperatures, enhancing cooking safety and efficiency.

According to other embodiments of the invention, an outlet valve to release excess pressure by venting steam or air when needed is described. The valve may be positioned away from the cooking vessel using an elongated metal pipe, with evenly distributed fins along the pipe for cooling. Additionally, in some configurations, cold air can be blown onto the pipe to reduce its temperature. Moreover, a steam or air pump, responsible for managing air or steam flow, is placed behind the valve. This arrangement ensures that the pump remains protected from direct exposure to extreme searing temperatures, thereby preserving its functionality and safety. In another embodiment, a method of measuring pressure using the back electromotive force (EMF) concept by monitoring the current supplied to the pump motor is described. As the pump pushes air or steam into the cooking apparatus, the pressure inside becomes directly proportional to the motor's current demand. The method can help eliminate the need for a separate pressure sensor and provide a reliable means of pressure measurement.

According to other embodiments of the invention, a novel approach for providing a fan inside the cooking apparatus is described. The system comprises a bushing to strategically guide and support the motor shaft that connects to the fan blades. The bushing, made from durable materials such as brass or steel, may comprise external fins for rapid cooling. Importantly, this arrangement keeps the seal away from the main cooking vessel, hidden behind the cooling fins, so it stays at lower, safe temperatures, much cooler than searing levels.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1a is a perspective view of an example cooking apparatus in accordance with the subject disclosure.

FIG. 1b is a perspective view of an example cooking apparatus in accordance with the subject disclosure.

FIG. 2 is a schematic diagram illustrating the cooking apparatus valve in accordance with the various embodiments.

FIG. 3 is a schematic diagram illustrating the fan mechanism in the cooking apparatus in accordance with the various embodiments.

### DETAILED DESCRIPTION

The subject disclosure is directed to cooking foodstuffs such as meats and vegetables, in a faster, more efficient manner. More particularly, the invention relates to pressure cooker valves used for cooking the foodstuff in a pressurized steam oven with the foodstuff being steam cooked in a first stage and seared in a second stage.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, the foodstuff comprises foods items such as meat (e.g., bacon, pork chops, sausage, hamburger patties), poultry (e.g., whole turkey, chicken breasts or wings), seafood, vegetables (e.g., French fries, peppers), convenience or snack foods (e.g., burritos), pizza, breads, cookies, and pastries. It should be understood to one having ordinary skill in the art that foodstuff can comprise any variations of the above-mentioned food items marinated or lathered in oil or other substances.

Reverse searing is a two-step cooking technique that involves cooking a foodstuff slowly at a low temperature in the first step, and then searing it at a high temperature for a short period of time at the end of the cooking process in the second step. The result is a piece of foodstuff that is evenly cooked throughout and has a delicious, caramelized sear on the outside. However, the problem with the conventional reverse sear method of cooking foodstuff is that a user needs to take out the food from the oven and check the food item with a thermometer to measure the internal temperature while it is being slowly cooked at the first step. It is not easy for a person cooking the food to understand exactly when to stop the slow cook and start searing the food so that it is not overcooked. The foodstuff may not develop a proper sear or crust if the initial low temperature cooking is not done evenly or accurately. Foodstuff may be overcooked if the internal temperature reaches the critical temperature before foodstuff goes into the fast cooking or searing stage. Additionally, convection-based methods heat the foodstuff from outside using high temperatures until the foodstuff is cooked from the inside. This may cause the juices in the foodstuff to evaporate and the foodstuff to become dry. So, it is important to monitor the cooking process closely and to adjust the temperature and cooking time as needed to ensure that the foodstuff is cooked to the desired level of doneness, i.e. juicy on the inside and crispy on the outside.

In some embodiments of the invention, more than two stages and more than two cooking methods can be used for cooking the foodstuff in the oven. It should also be understood that the multiple cooking steps can be performed in any suitable order without deviating from the scope of the proposed invention. In some embodiments of the invention, the first cooking method can be searing of the foodstuff and the second cooking method can be slow steam cooking of the foodstuff. In this case, the time and parameters of the searing step can be adjusted based on the time and parameters of the slow cooking step so that the critical temperature of the foodstuff is reached after the second stage slow cooking.

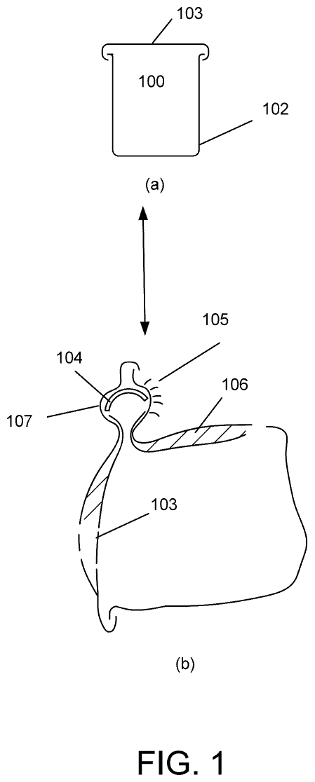

In FIG. 1a there is disclosed a cooking apparatus 100 made in accordance with the present invention. The cooking apparatus 100 comprises a vessel or cooking chamber 102 to place the foodstuff to be cooked. In accordance with the invention, the cooking apparatus 100 includes a lid 103, designed for precise fitting and locking onto the vessel 102. The lid 103 cooperates with a gasket to form a sealed cooking enclosure, effectively regulating the pressure within the cooking apparatus. The cooking apparatus 100 incorporates a 3D scanning module comprising one or more cameras and an infrared sensor to construct a real-time three-dimensional model of the foodstuff placed within the vessel or cooking chamber. The system calculates the precise cooking time and temperature by analyzing the food's dimensions and thermal properties. The cooking apparatus further comprises a steam generator and an air compressor which enables accelerated cooking faster than traditional sous-vide techniques while maintaining precise thermal control. In a preferred embodiment, the cooking apparatus operates in two phases to provide a perfectly cooked food in a single cooking cycle. In the first phase, the food is cooked at a low-temperature. In the next cooking phase, the double-wall cooking apparatus 100 rapidly shifts to a searing mode. In an exemplary embodiment, the cooking apparatus 100 can achieve the searing temperature up to 285° C. (550° F.) within 60 seconds. The cooking apparatus enables to provide a golden crust on the foodstuff without compromising internal moisture in a single cooking cycle.

According to a preferred embodiment of the invention, as shown in another perspective view of the cooking apparatus 100 in FIG. 1b, the cooking vessel 102 and the lid 103 exhibit a double-walled construction, with insulation 106 sandwiched between the two layers. At the top of the cooking apparatus 100, the double walls of the lid 103 are squished into a single wall and insulation terminates at the edge. A valve 107 is provided on the lid 103. The lid 103 may be extended up to half of an inch so a cavity can be created to form a valve 107. The valve 107 is strategically positioned slightly away from the lid 103, permitting the surrounding environment to effectively cool it down to a more manageable temperature, typically around 250° F. A seal 104, provided inside the valve 107, completely seal the vessel. The valve is designed in such a manner that the seal 104 is positioned away from the main vessel. Since the valve is not insulated, the outside environment cools down the valve to a lower temperature such as 250° F., which ensures the survival of the silicon or rubber seal 104 within the valve. Additionally, the seal 104 disposed within said valve 107 is configured to ensure a complete closure of the cooking vessel 102, wherein said seal is thermally insulated by being spatially separated from the hot air circulating within the cooking chamber. The lid enclosure also has a bigger surface cooling area which helps in creating a cooler environment near the seal. One or more components of the valve including the seal 104, while positioned within the internal air environment, is not in direct contact with the heated airflow due to a predetermined separation distance, thereby creating a localized cooler air region. Further, the separation reduces heat transfer from the main chamber to the valve, and also increases the heat transfer to the air through the elongated pipe so that the air gets cooler. In the preferred embodiment, the disclosed structural arrangement positions the sealing mechanism at an offset distance from the heated interior, which reduces thermal exposure and enhances the durability and operational reliability of the sealing material.

In an alternate embodiment, fins 105 are thoughtfully integrated around and over the valve 107 to expedite cooling. In certain configurations, cold air can be actively directed toward the valve 107 for rapid cooling. One of the advantages of this arrangement is that even though the internal temperature of the cooking apparatus is at a searing temperature (near 350° F.) , the seal 104 is not exposed to that high temperature, making the seal safer.

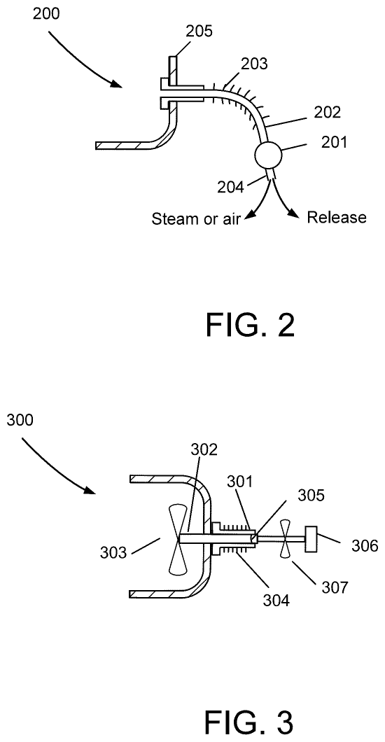

FIG. 2 shows another perspective view 200 of the cooking apparatus 100. When excessive pressure builds up inside the vessel 102, an outlet valve 201 is configured to release the steam or hot air and regulate the pressure inside the vessel. Additionally, during transitions between cooking phases, such as from a low temperature cooking phase to a searing phase, the cooking apparatus should release the pressure. In a preferred embodiment of the invention, the valve 102 is strategically provided at any suitable location on the cooking apparatus 100 so that in the event of steam or hot air release due to the high pressure inside the chamber or due to any mechanical failure of the valve, risk of user injury is minimized. Similarly, the outlet valves may also fail at very high searing temperatures. To reduce the valve failure due to the very high temperature steam or hot air coming out of the cooking vessel, the valve 201 is intentionally positioned slightly farther from the vessel, facilitated by an elongated metal pipe 202. It should be understood that the hot air or steam entering or exiting the cooking chamber may affect the durability of the provided valve on the supply pipe. Consequently, steam inlet valves that releases steam from the steam engine in to the cooking chamber, may fail due to the pressure inside the cooking chamber. To mitigate potential failure due to pressure fluctuations within the cooking chamber, the inlet valve is positioned away from the chamber in such a manner that, in the event of blowback, the incoming steam or hot air is sufficiently cooled before reaching the valve. In a preferred embodiment, fins 203 may be provided and are evenly distributed along the length of the pipe to cool the pipe down.

In some embodiments, cold air can also be blown to the pipe to cool it down from the searing temperature of 350° F. to a more manageable temperature, approximately 200° F. In the preferred embodiments of the invention, a steam or air pump 204 responsible for managing air or steam flow to and from the cooking vessel is positioned behind the valve 201, ensuring that the steam or air pump 204 remains shielded from direct exposure to the extreme searing temperatures, preserving its functionality and safety. The valve is positioned at the distal end of an elongated metal pipe extending from the cooking apparatus, thereby spatially separating the valve from the main cooking chamber. The disclosed arrangement minimizes direct heat exposure to the valve, ensuring reliable operation under high-temperature conditions. To further enhance thermal regulation, a plurality of fins is distributed along the length of the metal pipe, facilitating efficient heat dissipation by increasing the surface area exposed to the surrounding environment. The strategic placement of the valve, in combination with the cooling effect of the fins, maintains a lower temperature at the valve location, thereby preserving the integrity of sealing components and ensuring consistent pressure release performance.

FIG. 3 illustrates a cross-section view of a cooking apparatus 100, according to an embodiment of the invention. Currently, no stream cooker or pressured ovens incorporate a fan mechanism for efficient air or steam circulation within the cooking vessel. One of the challenges associated with integrating a fan inside the potential leakage of air or steam through the hole provided for the motor shaft connecting to the fan blades. Although some arrangements include a rubber sprung seal to curtail steam leakage and maintain pressure, these rubber seals are susceptible to degradation at high searing temperatures, such as 350° F. An arrangement 300 shown in the FIG. 3 resolves this issue. A bushing 301 can be ingeniously introduced to guide and support the motor shaft 302 as it passes through the bushing 301. A motor 306 drives the fan blades 303, facilitating efficient circulation. The bushing 301 can be made with brash or steel or any suitable metal providing the sufficient strength. In some embodiments, fins 304 are thoughtfully incorporated onto the outer surface of the bushing 301 to expedite cooling. The inclusion of the bushing 301 allows the seal 305 to be positioned away from the main cooking vessel, strategically placed behind the cooling fins 304, ensuring that it remains exposed to lower temperatures, well below the searing temperature.

It should be understood that due to the pressurized environment within the pot, minimal to no steam or hot air flow occurs between the interior of the pot and the bushing, eliminating the risk of steam or hot air reaching the seal 305. Furthermore, the steam may undergo cooling to a temperature lower than the searing temperature before reaching the seal. Using an elongated bushing 301, seal 305 can be placed away from the vessel. In another embodiment, an external fan 307 is introduced outside the vessel to efficiently cool both the motor 306 and the bushing 301.

According to another embodiment of the invention, pressure sensing functionality can be implemented through the valve 201 and the air or steam pump 204. The air or steam pump 204 plays a vital role in maintaining pressure by introducing air or steam into the cooking apparatus. Pressure measurement is ingeniously achieved through the monitoring of current supplied to the pump motor, utilizing the concept of back electromotive force (EMF). Back EMF is a voltage or electromotive force that opposes the current flow in electric motors and when they are in operation. Increased current is required when the electric motor's workload increases. Thus, as air or steam is introduced into the cooking apparatus, the pressure inside the cooking apparatus becomes directly proportional to the current required to operate the motor to push the air or steam. Instead of implementing a dedicated pressure sensor to determine the pressure inside the cooking apparatus, the supplied current to the pump motor can be measured periodically. As the pump motor is started to push the air inside the pot of the cooking apparatus, the force required to push the air or steam is measured. In some embodiments, the force or current is measured periodically, say every 5 mins. The measured forced can be a reliable indicator of the pressure inside the cooking apparatus. In accordance with the present invention, a method is provided for regulating pressure within a cooking apparatus by utilizing the electromotive force (EMF) of a motor as a sensing mechanism to determine the internal pressure of the cooking chamber. Unlike conventional pressure regulation systems that rely on dedicated pressure sensors, this method eliminates the need for additional sensors by analyzing the motor's workload as an indirect measure of pressure. During operation, the motor is periodically activated to introduce or regulate pressure within the cooking chamber. The EMF generated by the motor is continuously monitored to assess the resistance encountered when pushing air or steam into the chamber. If the EMF indicates that the motor is working harder, it suggests a higher internal pressure, prompting the system to stop increasing pressure. Conversely, if the EMF values suggest lower resistance, it indicates a drop in pressure, allowing the system to add more air or steam as needed. By dynamically adjusting pressure based on the motor's EMF readings, the method ensures precise and efficient pressure control, optimizing cooking conditions while reducing system complexity and cost.

In a preferred embodiment of the invention, the cooking apparatus 100 may include a thermometer to continuously measure the temperature of the foodstuff cooking in the cooking chamber. The thermometer can provide dynamic feedback to adjust temperature and pressure inside the cooking chamber in real-time. In some embodiments of the invention, the thermometer can be adapted to be inserted into the foodstuff to be cooked by the cooking apparatus.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A cooking apparatus, comprising:
a flow control mechanism for releasing excess pressure from hot air or steam within the cooking apparatus;
an elongated metal pipe extending from the cooking apparatus to position the flow control mechanism at a distance from the cooking chamber, wherein the flow control mechanism is disposed at the distal end of the metal pipe; and a plurality of fins distributed along the length of the metal pipe, the fins being configured to enhance heat dissipation and reduce the temperature of the flow control mechanism for improved thermal protection.

2. The cooking apparatus of claim 1, wherein the flow control mechanism is a valve regulating the pressure in the cooking chamber.

3. The cooking apparatus of claim 2, wherein a plurality of fins integrated into or around the valve.

4. A cooking apparatus, comprising:
a steam engine to supply steam to the cooking chamber;
a valve for managing the steam reflux;
an elongated metal pipe extending from the cooking apparatus to position the valve at a distance from the cooking chamber, wherein the valve is disposed at the distal end of the metal pipe; and
a plurality of fins distributed along the length of the metal pipe, the fins being configured to enhance heat dissipation and reduce the temperature of the valve for improved thermal protection.

5. A method for pressure measurement within a cooking apparatus, the method comprises:
initiating a pump that introduces air or steam to the cooking apparatus using;
monitoring the current supplied to the pump motor responsible for introducing air or steam into the cooking apparatus;
determining the voltage or electromotive force opposing the current flow in the pump motor;
calculating the pressure inside the cooking apparatus, wherein, the pressure inside the cooking apparatus is directly proportional to the current required to operate the motor to push the air or steam.

6. The method of pressure measurement according to claim 5, wherein the monitoring of current supplied to the pump motor is performed periodically.

7. A cooking apparatus, comprising:
a fan mechanism for efficient air or steam circulation within a cooking vessel; the fan mechanism comprising:
fan blades connected to a motor shaft;
a motor to rotate the fan blades;
a bushing to guide and support the motor shaft as it passes through the bushing;
a seal to provide closure to maintain the pressure inside the cooking apparatus, wherein said seal is positioned strategically away from the cooking vessel to avoid damage due to the high searing temperature;
external fins on the said bushing for rapid cooling.

8. The cooking apparatus of claim 7, wherein, the said bushing is made from any suitable metal providing strength and durability, such as brass or steel.

9. The cooking apparatus of claim 7, wherein, the cooking apparatus further comprises an external fan positioned outside the cooking vessel to facilitate the efficient cooling of both the motor and the bushing.
